(19) United States
(12) Patent Application Publication
(10) Pub. No.: US 2024/0422195 A1
(43) Pub. Date: Dec. 19, 2024

(54) DATA-PLANE APPROACH FOR POLICY CONFIGURATION

(71) Applicant: VMWARE, INC., Palo Alto, CA (US)

(72) Inventors: VASANTHA KUMAR DHANASEKAR, Pune (IN); DIMITRIOS SIKERIDIS, Mountain Veiw, CA (US); SHIRISH VIJAYVARGIYA, Pune (IN); SRIRAM GOPALAKRISHNAN, Pune (IN)

(21) Appl. No.: 18/230,695

(22) Filed: Aug. 7, 2023

(30) Foreign Application Priority Data
Jun. 17, 2023 (IN) 202341041321

(51) Int. Cl. H04L 9/40; G06F 9/455

(52) U.S. Cl. CPC H04L 63/166; G06F 9/45558; G06F 2009/45595

(57) ABSTRACT

Example methods and systems for policy configuration using a data-plane approach are described. In one example, a first computer system may detect first data- plane packet(s) for establishing a connection between (a) a first virtualized computing instance and (b) a second computer system from which a resource is accessible. The first computer system may extract, from the first data-plane packet(s), parameter information associated with the connection; and configure a policy that is applicable for access control of the resource based on the parameter information. In response to detecting second data-plane packet(s) to access the resource, the computer system may apply the policy to allow or block forwarding of the second data-plane packet towards the second computer system. The second data-plane packet may originate from (a) the first virtualized computing instance or (b) a second virtualized computing instance supported by the first computer system.

### RELATED APPLICATIONS

Benefit is claimed under 35 U.S.C. 119(a)-(d) to Foreign application Ser. No. 20/234,1041321 filed in India entitled “DATA-PLANE APPROACH FOR POLICY CONFIGURATION”, on Jun. 17, 2023, by VMware, Inc., which is herein incorporated in its entirety by reference for all purposes.

### BACKGROUND

Virtualization allows the abstraction and pooling of hardware resources to support virtual machines in a software-defined data center (SDDC). For example, through server virtualization, virtualized computing instances such as virtual machines (VMs) running different operating systems may be supported by the same physical machine (e.g., host). Each VM is generally provisioned with virtual resources to run a guest operating system and applications. The virtual resources may include central processing unit (CPU) resources, memory resources, storage resources, network resources, etc. In practice, it is desirable to configure policies to, for example, detect potential security threat(s) in the SDDC.

### BRIEF DESCRIPTION OF DRAWINGS

FIG. 1 is a schematic diagram illustrating an example software-defined networking (SDN) environment in which a data-plane approach for policy configuration may be performed;

FIG. 2 is a schematic diagram illustrating an example data-plane approach for policy configuration;

FIG. 3 is a flowchart of an example process for a first computer system to implement a data-plane approach for policy configuration;

FIG. 4 is a flowchart of an example detailed process for a first computer system to implement a data-plane approach for policy configuration;

FIG. 5 is a schematic diagram illustrating an example data-plane approach for policy configuration in an SDN environment;

FIG. 6 is a schematic diagram illustrating an example policy enforcement phase of the example in FIG. 5;

FIG. 7 is a schematic diagram illustrating an example data-plane approach for updated policy configuration in an SDN environment; and

FIG. 8 is a schematic diagram illustrating an example policy enforcement phase of the example in FIG. 7.

### DETAILED DESCRIPTION

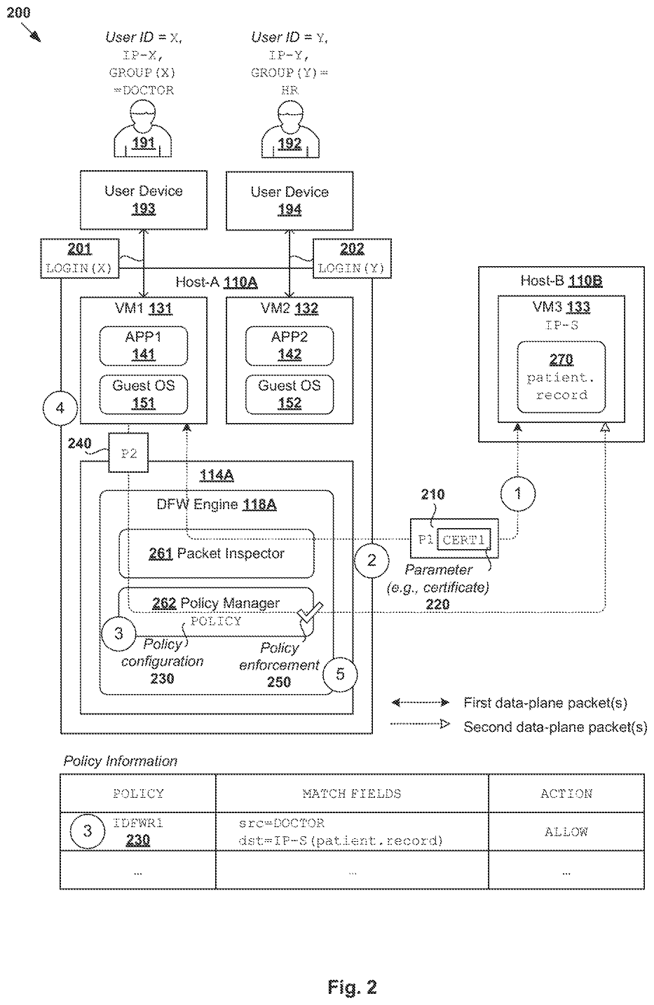

According to examples of the present disclosure, policy configuration may be implemented in a more efficient manner using a data-plane approach. In one example, a first computer system (e.g., host-A 110A in FIG. 2) may detect first data-plane packet(s) for establishing a connection between (a) a first virtualized computing instance (e.g., client=VM1 131 in FIG. 2) and (b) a second computer system (e.g., server=VM3 133 in FIG. 2) from which a resource is accessible. The first computer system may extract, from the first data-plane packet(s), parameter information associated with the connection; and configure a policy that is applicable for access control of the resource based on the parameter information. In response to detecting second data-plane packet(s) to access the resource, the computer system may apply the policy to allow or block forwarding of the second data-plane packet towards the second computer system. The second data-plane packet may originate from (a) the first virtualized computing instance (e.g., VM1 131 in FIG. 2) or (b) a second virtualized computing instance (e.g., VM2 132 in FIG. 2).

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the drawings, can be arranged, substituted, combined, and designed in a wide variety of different configurations, all of which are explicitly contemplated herein. Although the terms “first” and “second” are used to describe various elements, these elements should not be limited by these terms. These terms are used to distinguish one element from another. For example, a first element may be referred to as a second element, and vice versa.

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the drawings, can be arranged, substituted, combined, and designed in a wide variety of different configurations, all of which are explicitly contemplated herein. Throughout the present disclosure, it should be understood that although the terms “first” and “second” are used to describe various elements, these elements should not be limited by these terms. These terms are used to distinguish one element from another. A first element may be referred to as a second element, and vice versa.

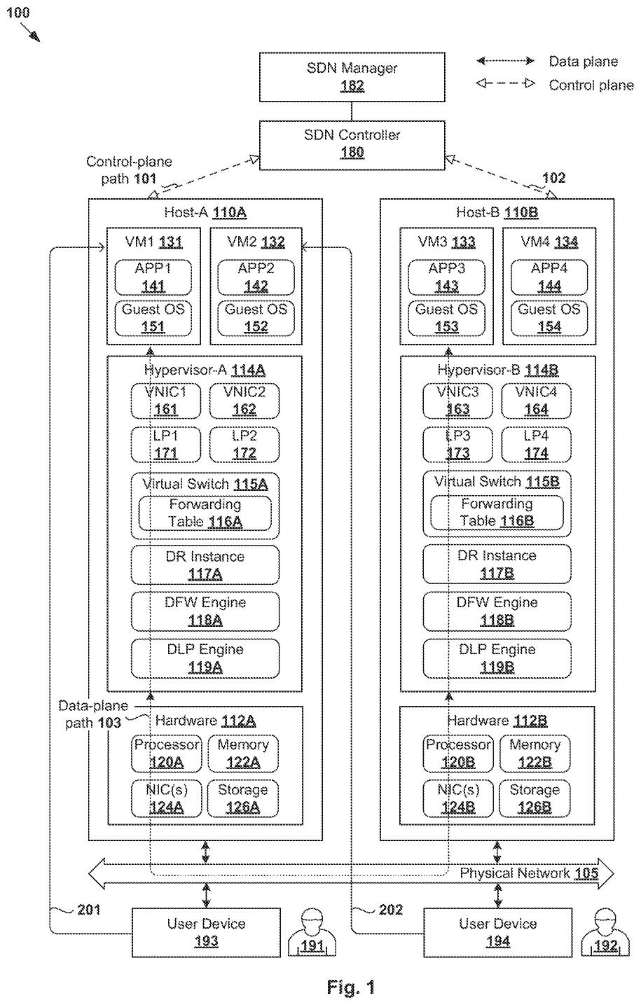

FIG. 1 is a schematic diagram illustrating example software-defined networking (SDN) environment 100 in which a data-plane approach for policy configuration may be performed. It should be understood that, depending on the desired implementation, SDN environment 100 may include additional and/or alternative components than that shown in FIG. 1. SDN environment 100 includes multiple hosts 110A-B that are inter-connected via physical network 105. In practice, SDN environment 100 may include any number of hosts (also known as a “host computers”, “host devices”, “physical servers”, “server systems”, “transport nodes,” etc.), where each host may be supporting tens or hundreds of virtual machines (VMs).

Each host 110A/110B may include suitable hardware 112A/112B and virtualization software (e.g., hypervisor-A 114A, hypervisor-B 114B) to support various VMs. For example, hosts 110A-B may support respective VMs 131-134. Hypervisor 114A/114B maintains a mapping between underlying hardware 112A/112B and virtual resources allocated to respective VMs. Hardware 112A/112B includes suitable physical components, such as central processing unit(s) (CPU(s)) or processor(s) 120A/120B; memory 122A/122B; physical network interface controllers (NICs) 124A/124B; and storage disk(s) 126A/126B, etc.

Virtual resources are allocated to respective VMs 131-134 to support a guest operating system (OS; not shown for simplicity) and application(s) 141-144. For example, the virtual resources may include virtual CPU, guest physical memory, virtual disk, virtual network interface controller (VNIC), etc. Hardware resources may be emulated using virtual machine monitors (VMMs). For example in FIG. 1, VNICs 161-164 are virtual network adapters for VMs 131-134, respectively, and are emulated by corresponding VMMs (not shown for simplicity) instantiated by their respective hypervisor at respective host-A 110A and host-B 110B. The VMMs may be considered as part of respective VMs, or alternatively, separated from the VMs. Although one-to- one relationships are shown, one VM may be associated with multiple VNICs (each VNIC having its own network address).

Although examples of the present disclosure refer to VMs, it should be understood that a “virtual machine” running on a host is merely one example of a “virtualized computing instance” or “workload.” A virtualized computing instance may represent an addressable data compute node (DCN) or isolated user space instance. In practice, any suitable technology may be used to provide isolated user space instances, not just hardware virtualization. Other virtualized computing instances may include containers (e.g., running within a VM or on top of a host operating system without the need for a hypervisor or separate operating system or implemented as an operating system level virtualization), virtual private servers, client computers, etc. Such container technology is available from, among others, Docker, Inc. The VMs may also be complete computational environments, containing virtual equivalents of the hardware and software components of a physical computing system.

The term “hypervisor” may refer generally to a software layer or component that supports the execution of multiple virtualized computing instances, including system-level software in guest VMs that supports namespace containers such as Docker, etc. Hypervisors 114A-B may each implement any suitable virtualization technology, such as VMware ESX® or ESXi™ (available from VMware, Inc.), Kernel-based Virtual Machine (KVM), etc. The term “packet” may refer generally to a group of bits that can be transported together, and may be in another form, such as “frame,” “message,” “segment,” etc. The term “traffic” or “flow” may refer generally to multiple packets. The term “layer-2” may refer generally to a link layer or media access control (MAC) layer; “layer-3” to a network or Internet Protocol (IP) layer; and “layer-4” to a transport layer (e.g., using Transmission Control Protocol (TCP), User Datagram Protocol (UDP), etc.), in the Open System Interconnection (OSI) model, although the concepts described herein may be used with other networking models.

Hypervisor 114A/114B implements virtual switch 115A/115B and logical distributed router (DR) instance 117A/117B to handle egress packets from, and ingress packets to, corresponding VMs. In SDN environment 100, logical switches and logical DRs may be implemented in a distributed manner and can span multiple hosts. For example, logical switches that provide logical layer-2 connectivity, i.e., an overlay network, may be implemented collectively by virtual switches 115A-B and represented internally using forwarding tables 116A-B at respective virtual switches 115A-B. Forwarding tables 116A-B may each include entries that collectively implement the respective logical switches. Further, logical DRs that provide logical layer-3 connectivity may be implemented collectively by DR instances 117A-B and represented internally using routing tables (not shown) at respective DR instances 117A-B. The routing tables may each include entries that collectively implement the respective logical DRs.

Packets may be received from, or sent to, each VM via an associated logical port. For example, logical switch ports 171-174 are associated with respective VMs 131-134. Here, the term “logical port” or “logical switch port” may refer generally to a port on a logical switch to which a virtualized computing instance is connected. A “logical switch” may refer generally to a software-defined networking (SDN) construct that is collectively implemented by virtual switches 115A-B in FIG. 1, whereas a “virtual switch” may refer generally to a software switch or software implementation of a physical switch. In practice, there is usually a one-to-one mapping between a logical port on a logical switch and a virtual port on virtual switch 115A/115B. However, the mapping may change in some scenarios, such as when the logical port is mapped to a different virtual port on a different virtual switch after migration of the corresponding virtualized computing instance (e.g., when the source host and destination host do not have a distributed virtual switch spanning them).

Through virtualization of networking services in SDN environment 100, logical networks (also referred to as overlay networks or logical overlay networks) may be provisioned, changed, stored, deleted and restored programmatically without having to reconfigure the underlying physical hardware architecture. A logical network may be formed using any suitable tunneling protocol, such as Virtual extensible Local Area Network (VXLAN), Stateless Transport Tunneling (STT), Generic Network Virtualization Encapsulation (GENEVE), etc. For example, VXLAN is a layer-2 overlay scheme on a layer-3 network that uses tunnel encapsulation to extend layer-2 segments across multiple hosts which may reside on different layer 2 physical networks. In the example in FIG. 1, VM1 131 on host-A 110A and VM3 133 on host-B 110B may be connected to the same logical switch and located on the same logical layer-2 segment, such as a segment with VXLAN network identifier (VNI)=6000.

SDN controller 180 and SDN manager 182 are example network management entities in SDN environment 100. One example of an SDN controller is the NSX controller component of VMware NSX® (available from VMware, Inc.) that operates on a central control plane. SDN controller 180 may be a member of a controller cluster (not shown for simplicity) that is configurable using SDN manager 182 operating on a management plane. Network management entity 180/182 may be implemented using physical machine(s), VM(s), or both. Logical switches, logical routers, and logical overlay networks may be configured using SDN controller 180, SDN manager 182, etc. To send or receive control information, a local control plane (LCP) agent (not shown) on host 110A/110B may interact with SDN controller 180 via control- plane channel 101/102.

Hosts 110A-B may also maintain data plane connectivity with each other via physical network 105 to facilitate communication among VMs located on the same logical overlay network. Hypervisor 114A/114B may implement a virtual tunnel endpoint (VTEP) (not shown) to encapsulate and decapsulate packets with an outer header (also known as a tunnel header) identifying the relevant logical overlay network. For example in FIG. 1, hypervisor-A 114A implements a first VTEP associated with (IP address=IP-A, MAC address=MAC-A, VTEP label=VTEP-A), and hypervisor-B 114B a second VTEP with (IP-B, MAC-B, VTEP-B), etc. Encapsulated packets may be sent via an end-to-end, bi-directional communication path (known as a tunnel) between a pair of VTEPs over physical network 105.

### Data Center Security

One of the challenges in SDN environment 100 is improving the overall data center security. To protect VMs 131-134 against security threats caused by unwanted packets, hypervisor 114A/114B may implement distributed firewall (DFW) engine 118A/118B to filter packets to and from associated VM(s). For example, at host-A 110A, hypervisor 114A implements DFW engine 118A to filter packets for VM1 131 and VM2 132. In practice, packets may be filtered according to firewall rules at any point along the datapath from a source (e.g., VM1 131) to a physical NIC (e.g., 124A). In one embodiment, a filter component (not shown) may be incorporated into each VNIC 141-144 to enforce firewall rules that are associated with the VM (e.g., VM1 131) corresponding to that VNIC (e.g., VNIC 161). The filter components may be maintained by DFW engines 118A-B.

Conventionally, firewall configuration may involve network administrator(s) defining firewall rules via a user interface provided by SDN manager 182 on the management plane. Then, SDN manager 182 may determine the span of the firewall rules and push them towards the relevant hosts. In practice, this conventional approach for firewall configuration may be increasingly challenging to implement as the size of the data center increases because it is necessary to translate and push firewall rules to a large number of hosts or VMs. Further, whenever a new VM is provisioned, or any changes to access rights are required, SDN manager 182 may have to identify and push the appropriate firewall rule(s) for the VM. This may be a time-consuming and resource-intensive process, which is undesirable.

### Data-Plane Approach for Policy Configuration

According to examples of the present disclosure, policy configuration may be implemented in a more efficient manner using a data-plane approach (i.e., reduced or zero configuration via control plane). In particular, instead of pushing policies via management entity 180/182, examples of the present disclosure may be implemented to configure and apply policies in line with the data plane. As used herein, the term “data plane” may refer generally to a set of network function(s) or element(s) capable of forwarding traffic between two endpoints, such as client VM1 131 and server VM3 133 in FIG. 2. The term “data-plane packet” may refer generally to a unit of data (also known as traffic, message, datagram, segment, etc.) that is forwarded between two endpoints via the data plane.

In the example in FIG. 1, an example data plane (see 103) may include one or more logical network elements (e.g., logical port(s), logical switch(es) or logical router(s) implemented using hypervisor 114A/114B), policy enforcement engines (e.g., DFW engine 118A/118B and DLP engine 119A/119B), physical network elements (e.g., physical port(s), physical switch(es) or physical router(s) located in physical network 105), or any combination thereof. Example data-plane path 103 should be contrasted against control-plane path 101/102 that is utilized by management entity 180/182 to send control information to host 110A/110B. As such, the data-plane approach described in the present disclosure should be contrasted against conventional approaches that necessitate the use of management entity 180/182 to translate and push firewall rules towards DFW engine 118A/118B via control-plane path 101/102.

As used herein, the term “policy” may refer generally to one or more rules that are applicable during packet forwarding. Any suitable “policy” may be configured using examples of the present disclosure. In one example, the policy may be firewall rule(s) to detect potential security threat(s). In another example, the policy may be a data lost prevention (DLP) rule(s) to reduce the likelihood of information leakage, etc. In relation to firewall configuration, a firewall rule may be defined to specify match fields to be matched against tuple information of a packet flow, and an action (e.g., allow, block or log) to be performed in case of a match. Example tuple information for detecting security threat(s) may include source IP address, source port number (PN), destination IP address, destination PN, and protocol. As used herein, the term “security threat” or “malware” may be used as an umbrella term to cover hostile or intrusive software, including but not limited to botnets, viruses, worms, Trojan horse programs, spyware, phishing, adware, riskware, rootkits, spams, scareware, ransomware, or any combination thereof.

More recently, the rise of user mobility has driven the need for identity firewall systems (also known as identity-based firewall systems) capable of filtering packets based on a user's identity information, such as username, user identifier (ID), etc. In practice, network administrators may find it easier and more efficient to configure identity firewall rules. By comparison, to achieve the same level of protection for a group of users, a large set of traditional firewall rules may be required to cover all possible 5-tuple combinations. The term “identity firewall” may refer generally to a firewall capable of applying identity firewall policies that are configured based on a user's identity information to filter packets.

One example is shown in FIG. 2, which is a schematic diagram illustrating example data-plane approach for policy configuration 200. In this example, first user 191 may log onto VM1 131, and second user 192 associated with username or user ID=Y into VM2 132 using respective user devices 193-194. See 201-202 in FIG. 2. First user 191 may be associated with domain username or user ID=X and a member of Active Directory (AD) group=DOCTOR. Second user may be associated with domain username or user ID=Y and a member of AD group=NURSES. Using an identity firewall system, DFW engine 118A may filter packets to/from VM 131/132 based on the identity information of user 191/192 (including group membership).

Depending on the desired implementation, virtual desktop infrastructure (VDI) may be implemented to allow user 191/192 to host a desktop OS on VM 131/132 (i.e., VM-based desktop). In general, VDI is a technology developed to provide virtual rather than physical desktops to users 191-192, who may connect to the virtual desktops from different locations using different user devices 193-194. Through VDI, user 191/192 may access various applications 141/142 supported by VM 131/132, such as word processing application, web browser, email, videoconferencing application, etc.

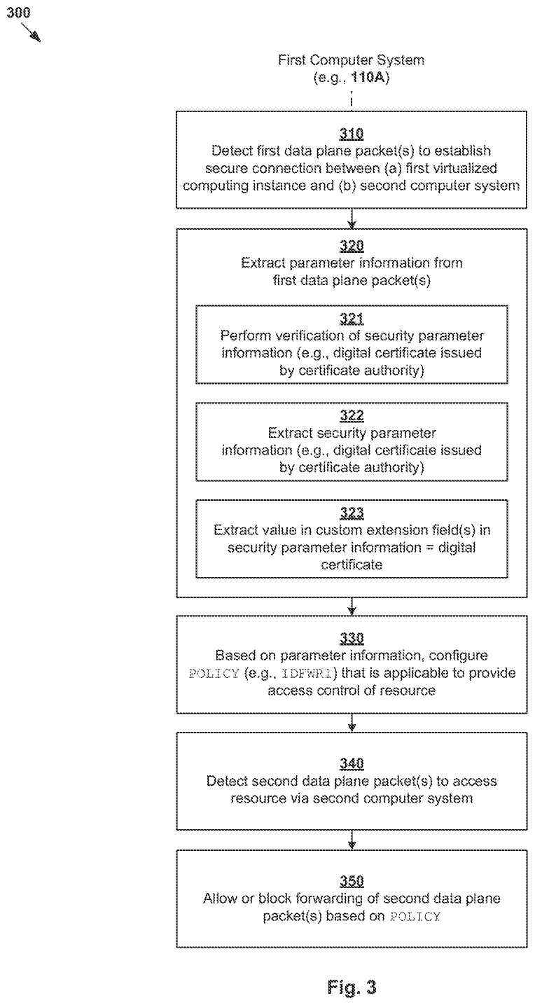

The example in FIG. 2 will be explained using FIG. 3, which is a flowchart of example process 300 for a first computer system to perform a data-plane approach for policy configuration. Example process 300 may include one or more operations, functions, or actions illustrated by one or more blocks, such as 310 to 350. Depending on the desired implementation, various blocks may be combined into fewer blocks, divided into additional blocks, and/or eliminated. In the following, various examples will be discussed using host-A 110A as an example “first computer system,” host-B 110B as an example “second computer system” and VMs 131-132 as example “virtualized computing instances.” Host 110A may implement examples of the present disclosure using any suitable hardware and/or software, such as DFW engine 118A, DLP engine 119A, etc. Engine 118A/119A may include any suitable hardware and/or software component(s), such as packet inspector 261, policy manager 262, etc.

At 210 in FIGS. 2 and 310 in FIG. 3, host-A 110A may detect first data-plane packet(s) to establish a connection between (a) VM1 131 supported by host-A 110A and (b) host-B 110B supporting VM3 133 from which a resource is accessible. For example, VM3 133 may be a web server via which resource(s) in the form of patient record(s) are accessible (see 270 in FIG. 2).

At 220 in FIGS. 2 and 320 in FIG. 3, host-A 110A may extract, from the first data-plane packet(s), parameter information associated with the secure connection. As used herein, the term “parameter information” may refer generally to one or more parameters or attributes associated with a connection between two endpoints. In one example, the parameter information may be security parameter information for establishing a secure connection between two endpoints, such as a digital certificate that is issued by a certificate authority (CA) to verify the identity of a server (e.g., VM3 133). In this case, block 320 may include performing verification of the digital certificate to verify an identity of server=VM3 133 on host-B 110B. The digital certificate may include custom extensions field(s) specifying value(s) based on which policy configuration may be performed below. See 321-323 in FIG. 3.

At 230 in FIGS. 2 and 330 in FIG. 3, based on the parameter information, host-A 110A may configure a policy that is applicable for access control of patient record(s) 270 from VM3 133 associated with IP address=IP-S. For example, the policy may be an identity firewall rule (IDFWR1) specifying (a) match fields that include source (src)=DOCTORS and destination (dst)=IP-S and (b) action=ALLOW. This means members of AD group=DOCTOR are allowed to access patient records 270. All other group(s) may be blocked from accessing patient records 270.

At 240-250 in FIGS. 2 and 340-350 in FIG. 3, in response to detecting a second data-plane packet to access resource(s) from VM3 133 on host-B 110B, host-A 110A may apply the policy to allow or block the second data-plane packet (denoted as P2 in FIG. 2). Once configured, the policy may be applied to data-plane traffic towards destination IP address=IP-S. For example in FIG. 2, second data-plane packet 240 may originate from VM1 131, or VM2 132 supported by host-A 110A after client=VM2 132 has successfully established a secure connection with server=VM3 133.

Using examples of the present disclosure, policy configuration may be performed more efficiently based on data-plane packet(s). When a new VM is provisioned on host-A 110A, for example, DFW engine 118A may apply configured policy=IDFWR1 230 on traffic from the new VM to the same destination. In at least some embodiments, it is not necessary to reconfigure the firewall rule(s) when new VMs are provisioned or access rights are updated. When a policy needs to be changed, the parameter information (e.g., certificate) may be modified and sent towards host-A 110A. This should be contrasted against conventional control plane approaches that necessitate translation from the updated policy in order to push it to a large number of hosts supporting various clients.

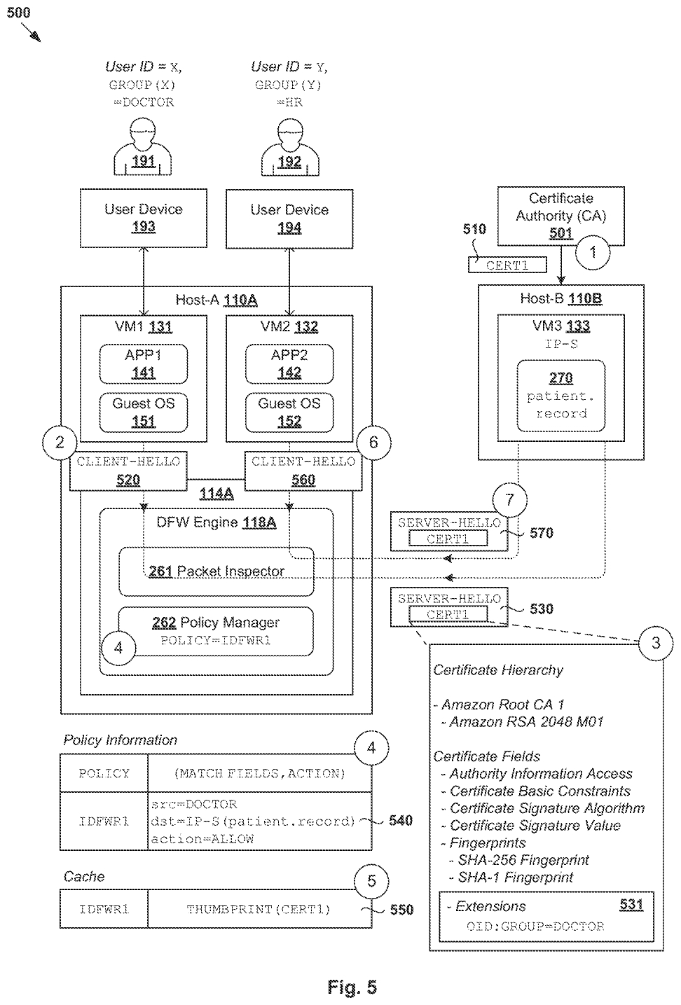

It should be understood that any suitable policies may be configured using examples of the present disclosure, such as firewall rules based on user's identity information (see identity firewall rules in FIGS. 5-7), application information, tuple information (e.g., IP address), location information, OS information (e.g., OS and patch version), security risk information (e.g., vulnerability risk score), etc. Besides firewall rules, examples of the present disclosure may be implemented to configure data loss prevention (DLP) policies (to be discussed below), etc.

Identify firewall rule configuration

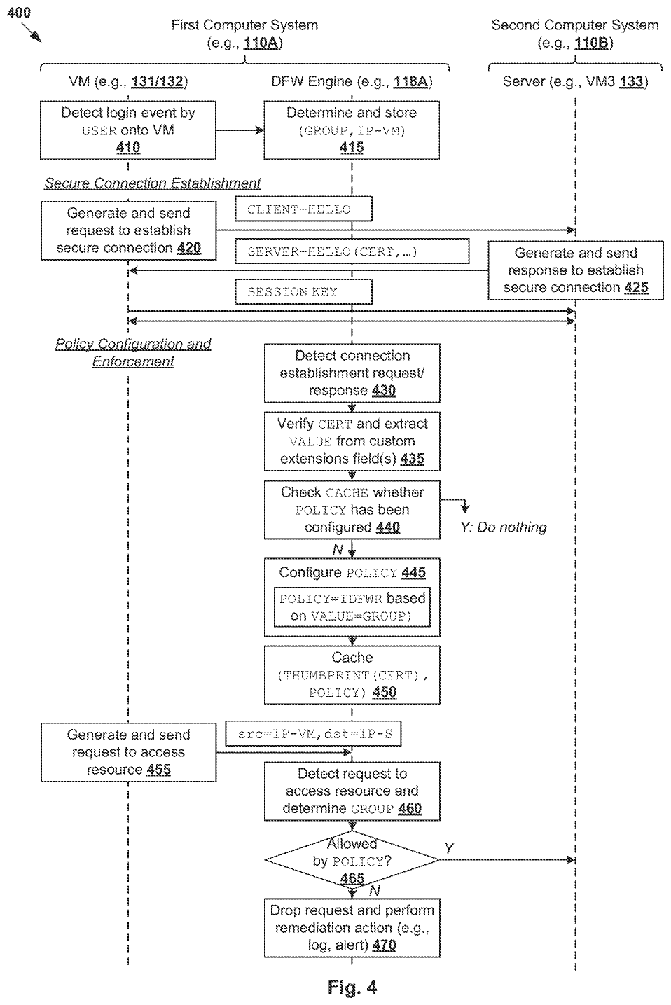

FIG. 4 is a flowchart of example detailed process 400 for a first computer system to implement a data-plane approach for policy configuration in an SDN environment. Example process 400 may include one or more operations, functions, or actions illustrated by one or more blocks, such as 410 to 470. Depending on the desired implementation, various blocks may be combined into fewer blocks, divided into additional blocks, and/or eliminated. The example in FIG. 4 will be explained using FIG. 5, which is a schematic diagram illustrating example data-plane approach 500 for policy configuration. Throughout the present disclosure, the term “obtaining” may refer generally to retrieving or receiving information from a source or any suitable datastore.

### (a) Login Event

At 410 in FIG. 4, user 191 operating user device 193 to log onto VM1 131. In practice, the login process may involve authenticating user 191 using any suitable identity management solution, such as Active Directory™ from Microsoft Corporation, VMware Identity Manager™ from VMware, Inc., etc. For example, user 191 may use any suitable Active Directory credentials, such as a user ID, password, etc. Depending on the desired implementation, a guest agent (also known as a “thin agent”) supported by guest OS 151 may be configured to capture events (e.g., login, logout, resource access, etc.) associated with VM1 131. The agent may be configured to report identity information (e.g., user ID=X, IP address=IP-VM1) to DFW engine 118A running on hypervisor-A 114A, such as via a Virtual Machine Communication Interface (VMCI) channel, etc.

At 415 in FIG. 4, in response to detecting a login event associated with user 191 logging onto VM1 131, DFW engine 118A may determine and store mapping information specifying (user ID=X, IP address=IP-VM1, group=DOCTOR) associated with VM1 131 to facilitate subsequent policy configuration and enforcement. In practice, the term “group” may refer generally to a collection of members that may be managed as a single unit, such as doctors, nurses, etc. Using nesting, a group (e.g., IN/OUTPATIENT DOCTOR) may be a member of another group (e.g., DOCTOR).

### (b) Secure Connection Establishment

At 420-425 in FIG. 4, client=VM1 131 may initiate a secure connection establishment process with server=VM3 133 using any suitable protocol. Using a TLS/SSL handshake as an example, a pair of client and server may exchange messages/packets (“first data-plane packets”) to verify each other's identities, agree on encryption algorithms and establish session keys. For example, a client may initiate a secure session establishment by sending a “CLIENT HELLO” packet that includes the client's random value (e.g., byte string) and supported cipher suites.

Next, the server may respond by sending a “SERVER HELLO” packet to the client, along with the server's random value. The server also sends its digital certificate to the client for authentication, along with a “SERVER HELLO DONE” packet. Based on the server's digital certificate, the client may verify the server's identity and check to ensure that the certificate is not expired, not revoked and its CA may be trusted. The client may encrypt a session key with a public key extracted from the server's digital certificate. The server may then decode the session key using its private key. The shared session key, which is now known by both the server and the client, may be used to encode and decode any packets sent during that session, thereby protecting message privacy, message integrity and server security. When the session ends, the session key is deleted.

Using the example in FIG. 5, CA 501 may issue digital certificate 510 to verify the identity of server=VM3 133 from which patient records 270 are accessible. Any suitable format may be used for digital certificate 510, such as an International Telecommunication Union (ITU) standard that defines the format of public key certificates called X.509, etc. X.509 certificates are used in many Internet protocols, including TLS/SSL that forms the basis for hypertext transfer protocol secure (HTTPS) for secure web browsing sessions. In practice, an X.509 certificate binds an identity to a public key using a digital signature.

### (c) Policy Configuration

At 430 in FIG. 4, DFW engine 118A (e.g., using packet inspector 261) may detect (or sniff) first data-plane packets for establishing a secure connection between VM1 131 and VM3 133, such as CLIENT HELLO packet 520 and/or SERVER HELLO packet 530 in FIG. 5. At 435, DFW engine 118A (e.g., using packet inspector 261) may perform certificate verification and extract parameter information associated with the secure connection, including digital certificate 510 from SERVER HELLO packet 530. In the example in FIG. 5, digital certificate 510 may include various fields, such as certificate version number, serial number, signature algorithm ID, issuer name, validity period, subject name, subject public key information (e.g., public key algorithm, subject public key), certificate signature algorithm, certificate signature value, etc. Prior to extracting the various fields, DFW engine 118A may verify the identity of server=VM3 133 by verifying digital certificate 510, such as by checking whether digital certificate 510 has expired or been revoked, etc.

According to examples of the present disclosure, digital certificate 510 (denoted as “CERT1”) may include custom extensions field(s) 531 based on which a data-plane approach for policy configuration may be performed. For example, extensions field 531 may include a unique object identifier (OID) and a value specifying an access control list, such as “group=DOCTOR.” This indicates that only members of group=DOCTOR are allowed to access patient records 270 via a web application running on VM3 133. The value may be in any suitable format, such as an unencrypted text string, encrypted value, etc. Note that extensions field(s) 531 may be used to specify multiple groups or nested groups, such as “group=(DOCTOR, NURSE),” etc.

At 440-445 in FIG. 4, in response to determination that a policy has not been configured based on digital certificate=CERT1 510, DFW engine 118A (e.g., using policy manager 262) may configure a policy, such as identity firewall rule(s), etc. For example in FIG. 5, an identity firewall rule denoted as IDFWR1 (see 540) may specify match fields (src=DOCTOR, dst=IP-S) and action=ALLOW based on extensions field 531. This means that all other groups will be blocked from accessing IP address=IP-S associated with VM3 134.

Using examples of the present disclosure, firewall rules may be passed in-line over the data plane to host-A 110A, and separate management entities are not required to perform span calculation and push those firewall rules. In particular, firewall rules that are expressed using high level attribute information such as AD group may be embedded in digital certificate 510 in an efficient manner. This should be contrasted against legacy firewall configurations through low level IP address format, which can get complicated for enterprises. Besides group membership information, firewall rules may be configured using other attribute(s), such as application information, tuple information (e.g., IP address), location information, etc.

To improve the trust level associated with information in digital certificate 510, block 445 may involve DFW engine 118A validating the certificate chain in digital certificate 510 to confirm it is signed by a trusted CA. In addition, DFW engine 118A may have trusted root CA and validate various fields (e.g., certificate name, date/time, revocation check) to confirm that digital certificate 510 is not tampered by any malicious party. Since the access control list (e.g., group=DOCTOR) information is bundled as part of digital certificate 510, it is therefore also signed by CA 501 and cryptographically verified by DFW engine 118A.

Depending on the desired implementation, examples of the present disclosure may be implemented for east-west traffic within a data center where hosted servers are usually managed by a security operations (SecOps) team that can be trusted. For example, in the healthcare scenario in FIGS. 4-8, a web portal supported by VM3 133 for accessing patient records may be managed by the SecOps team. In this case, digital certificate 510 may be added by the SecOps team and therefore associated with a high level of trust.

### (d) Caching

At 450 in FIG. 4, DFW engine 118A (e.g., using policy manager 262) may perform certificate hashing by updating a cache to reduce the overhead associated with policy decoding and configuration. For example in FIG. 5, a cache entry (see 550) that associates (a) policy=IDFWR1 540 with (b) a thumbprint associated with digital certificate 510 may be added to the cache. If another client=VM2 132 initiates a session establishment process using a CLIENT HELLO packet (see 560), it is not necessary for DFW engine 118A to repeat the policy configuration process based on a SERVER HELLO packet (see 570) from VM3 133. In particular, based on cache entry 550, DFW engine 118A may determine that IDFWR1 540 has been configured based on the same digital certificate 510 issued by CA 501.

### (e) Policy Enforcement

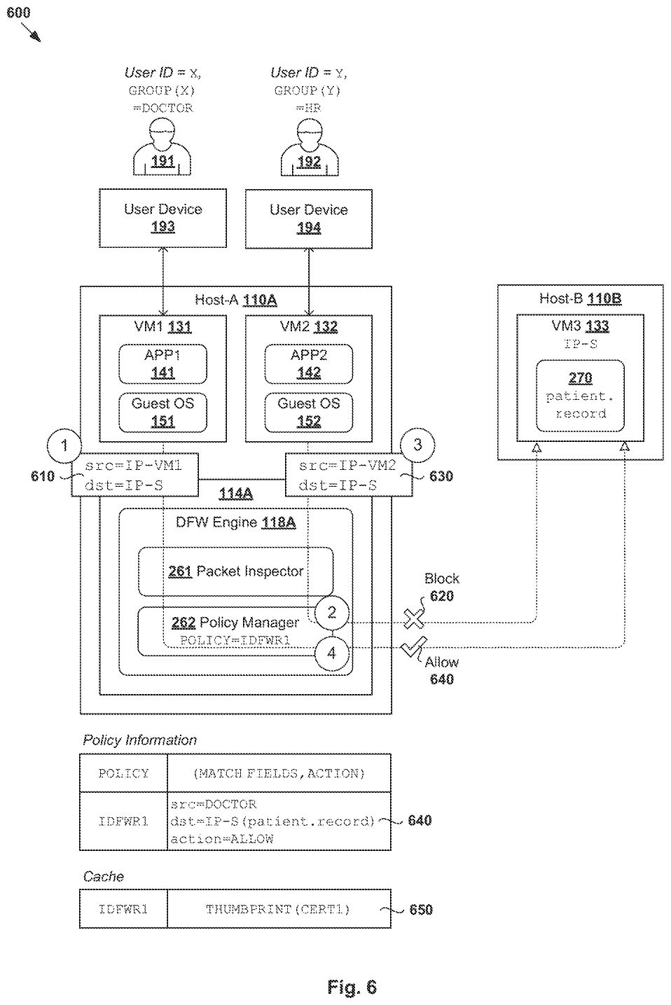

Blocks 455-470 in FIG. 4 will be described using FIG. 6, which is a schematic diagram illustrating example policy enforcement phase 600 of the example in FIG. 5. At 455-460 in FIG. 4, DFW engine 118A (e.g., using policy manager 262) may detect a request (“second data-plane packet”) to access patient records. At 465-470, DFW engine 118A may determine whether to allow or block the request based on the policy configured at block 445. If yes, the request may be forwarded towards VM3 133, but otherwise it is blocked.

In a first example in FIG. 6 (see 610-620), since first user 191 is a member of group=DOCTOR, DFW engine 118A may allow forwarding of a first request to access patient record(s) 270 towards VM3 133 based on IDFWR1 540. In a second example (see 630-640), since second user 192 is not a member of group=DOCTOR, DFW engine 118A may block a second request to access patient record(s) 270 based on the same IDFWR1 540. In practice, DFW engine 118A may also generate and send log information or alert(s) to management entity 182/180 and/or a network administrator.

### Updated Policy Configuration

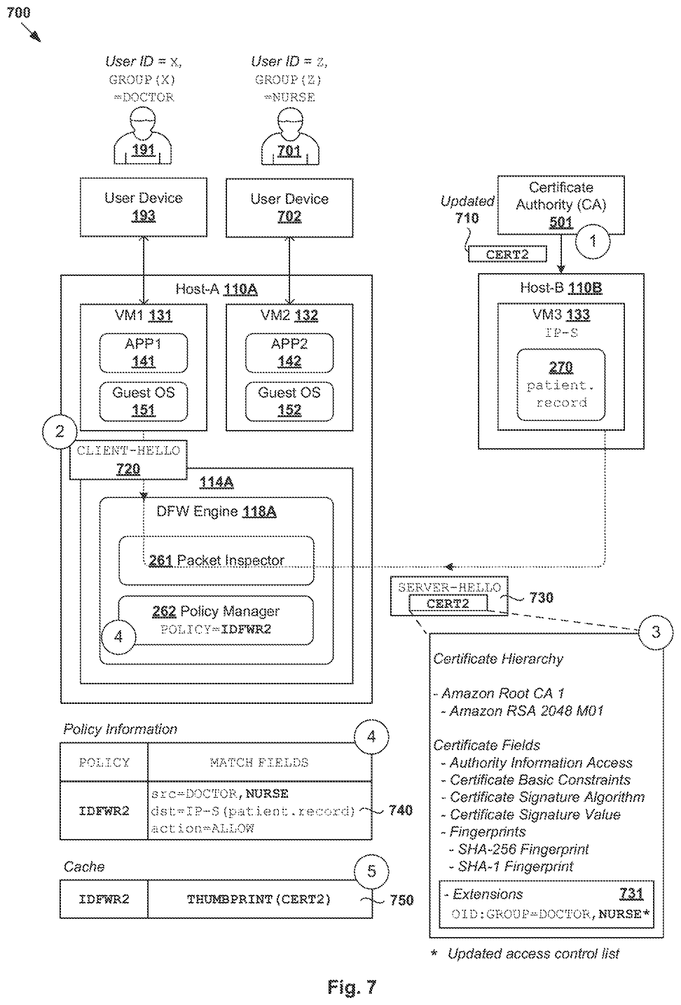

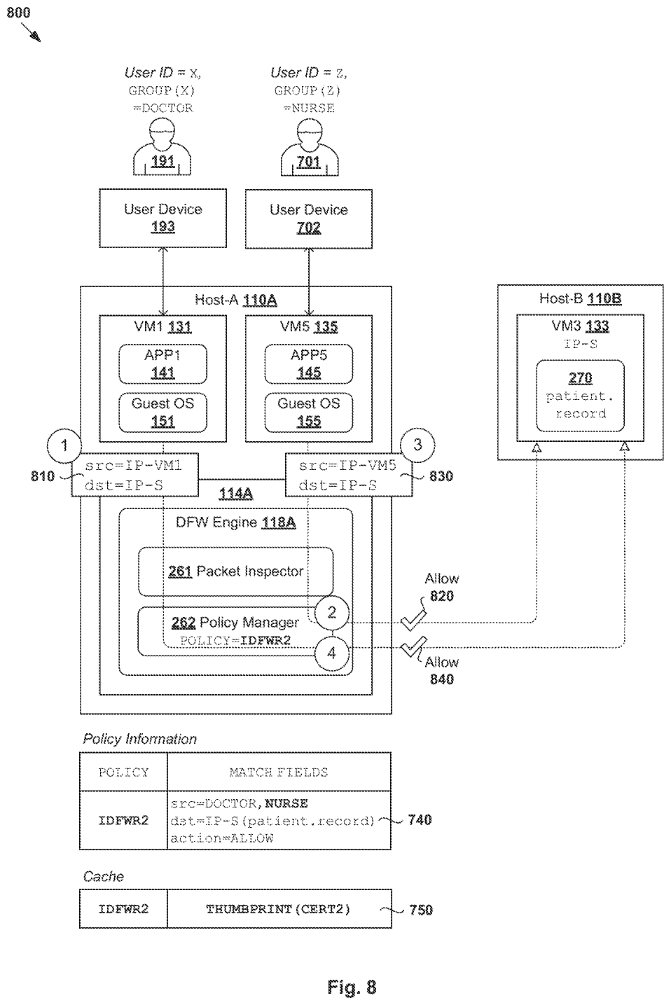

According to examples of the present disclosure, updated policies may be configured based on updated parameter information, such as updated digital certificate(s). This should be contrasted against conventional approaches that necessitate the involvement of the management plane or control plane. Some examples will be described using FIGS. 7-8. In particular, FIG. 7 is a schematic diagram illustrating example data-plane approach 700 for updated policy configuration in SDN environment 100. FIG. 8 is a schematic diagram illustrating example policy enforcement phase 800 of the example in FIG. 7.

Referring first to FIG. 7, at 710, CA 501 may issue server=VM3 133 with an updated digital certificate (denoted as “CERT2”) that includes an updated access control list specifying “group=(DOCTOR, NURSE).” In other words, in addition to members of a first group=DOCTOR, members of a second group=NURSE are granted permission to access patient records 270.

At 720-730 in FIG. 7, DFW engine 118A may detect or sniff first data-plane packets associated with the establishment of a secure connection between client=VM1 131 and server=VM3 133, such as CLIENT-HELLO packet, SERVER-HELLO packet, etc. At 731, DFW engine 118A may perform certificate verification and extract an updated digital certificate from SERVER-HELLO packet 730 that includes an updated extensions field specifying “group=(DOCTOR, NURSE).”

At 740 in FIG. 7, DFW engine 118A may configure an updated policy in the form of an identity firewall rule (“IDFWR2”) specifying (a) match fields src=(DOCTOR, NURSE) and dst=IP-S associated with VM3 133 and (b) action=ALLOW. At 750, DFW engine 118A may store a cache entry associating updated policy=IDFWR2 740 with a thumbprint associated with updated digital certificate=CERT2. Note that IDFWR1 540 and associated cache entry 550 in FIG. 5 that are no longer applicable may be removed or aged.

Referring now to FIG. 8, at 810-820, DFW engine 118A may apply IDFWR2 740 on second data-plane packet(s) from first client=VM1 131 to access patient records 270 via a web application supported server=VM3 133. Since user 191 is a member of group=DOCTOR, access will be allowed. Using examples of the present disclosure, IDFWR2 740 may be applied to second data-plane packet(s) from other client(s) supported by host-A 110A. For example, consider second user 701 who logs onto VM5 135 using user device 702 and establishes a secure connection with VM3 133. Second user 701 may be associated with user ID=Z and group=NURSE.

In the example in FIG. 8, it is not necessary to repeat the above policy configuration process based on the same updated digital certificate=CERT2. Instead, based on cache entry 750, DFW engine 118A may determine that IDFWR2 740 has been configured. Further, in response to detecting second data-plane packet(s) from second client=VM2 132 to access patient records 270 via server=VM3 133, DFW engine 118A may apply IDFWR2 740 to allow access since second user 701 is a member of group=NURSE. See 830-840 in FIG. 8.

### Data Loss Prevention (DLP)

Examples of the present disclosure may be implemented to configure DLP polices. For example, host 110A/110B may implement DLP engine 119A/119B (see FIG. 1) to prevent or reduce the risk of unintentional or intentional leakage of sensitive information. DLP engine 119A/119B may be configured to intercept SSL/TLS traffic to check for any sensitive information and determine whether to allow or block the transfer of the sensitive information. Instead of receiving configuration information from management entity 180/182, DLP engine 119A on host-A 110A may fetch a DLP policy inline through SSL/TLS traffic, such as TLS certificate.

In one example, a security administrator may configure a DLP policy to prevent members of group=NURSE from viewing payment and credit card information of patients. Based on first data-plane packet(s) detected during an SSL/TLS handshake process, DLP engine 119A/119B may configure the DLP policy based on information embedded in an extensions field of a digital certificate extracted from a SERVER-HELLO packet. The DLP policy may then be applied to second data-plane packet(s) to allow or block access to sensitive information.

### Container Implementation

Although discussed using VMs 131-135, it should be understood that examples of the present disclosure may be performed for other virtualized computing instances, such as containers, etc. The term “container” (also known as “container instance”) is used generally to describe an application that is encapsulated with all its dependencies (e.g., binaries, libraries, etc.). For example, multiple containers may be executed as isolated processes inside VM1 131, where a different VNIC is configured for each container. Each container is “OS-less”, meaning that it does not include any OS that could weigh 10s of Gigabytes (GB). This makes containers more lightweight, portable, efficient and suitable for delivery into an isolated OS environment. Running containers inside a VM (known as “containers-on-virtual-machine” approach) not only leverages the benefits of container technologies but also that of virtualization technologies.

### Computer System

The above examples can be implemented by hardware (including hardware logic circuitry), software or firmware or a combination thereof. The above examples may be implemented by any suitable computing device, computer system, etc. The computer system may include processor(s), memory unit(s) and physical NIC(s) that may communicate with each other via a communication bus, etc. The computer system may include a non-transitory computer-readable medium having stored thereon instructions or program code that, when executed by the processor, cause the processor to perform processes described herein with reference to FIG. 1 to FIG. 8. For example, a computer system capable of acting as host 110A/110B may be deployed in SDN environment 100 to perform examples of the present disclosure.

The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), and others. The term ‘processor’ is to be interpreted broadly to include a processing unit, ASIC, logic unit, or programmable gate array etc.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or any combination thereof.

Those skilled in the art will recognize that some aspects of the embodiments disclosed herein, in whole or in part, can be equivalently implemented in integrated circuits, as one or more computer programs running on one or more computers (e.g., as one or more programs running on one or more computing systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

Software to implement the techniques introduced here may be stored on a non-transitory computer-readable storage medium and may be executed by one or more general-purpose or special-purpose programmable microprocessors. A “computer-readable storage medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.). A computer-readable storage medium may include recordable/non recordable media (e.g., read-only memory (ROM), random access memory (RAM), magnetic disk or optical storage media, flash memory devices, etc.).

The drawings are only illustrations of an example, wherein the units or procedure shown in the drawings are not necessarily essential for implementing the present disclosure. Those skilled in the art will understand that the units in the device in the examples can be arranged in the device in the examples as described or can be alternatively located in one or more devices different from that in the examples. The units in the examples described can be combined into one module or further divided into a plurality of sub-units.

What is claimed is:

1. A method for a first computer system to perform a data-plane approach for policy configuration, wherein the method comprises:
detecting one or more first data-plane packets for establishing a connection between (a) a first virtualized computing instance supported by the first computer system and (b) a second computer system from which a resource is accessible;
extracting, from the one or more first data-plane packets, parameter information associated with the connection;
based on the parameter information, configuring a policy that is applicable for access control of the resource; and
in response to detecting a second data-plane packet to access the resource, applying the policy to allow or block forwarding of the second data-plane packet towards the second computer system, wherein the second data-plane packet originates from (a) the first virtualized computing instance or (b) a second virtualized computing instance supported by the first computer system.

2. The method of claim 1, wherein extracting the parameter information comprises:
performing verification of the parameter information in the form of a digital certificate that is issued by a certificate authority, wherein the digital certificate is extractable from a particular first data-plane packet from the second computer system.

3. The method of claim 2, wherein configuring the policy comprises:
configuring the policy based on at least one extensions field of the digital certificate, wherein the extensions field specifies an access control list associated with the resource.

4. The method of claim 2, wherein the method further comprises:
generating and storing a cache entry associating the policy with a thumbprint of the digital certificate, wherein the cache entry is subsequently accessible to determine whether the policy has been configured.

5. The method of claim 1, wherein configuring the policy comprises:
configuring the policy in the form of an identity firewall rule that is applicable by a firewall engine supported by the first computer system, wherein the identity firewall rule specifies at least one group of users that is permitted to access the resource.

6. The method of claim 5, wherein applying the policy comprises:
determining whether a first user associated with the first virtualized computing instance, or a second user associated with the second virtualized computing instance, is a member of the group specified by the identity firewall rule.

7. The method of claim 1, wherein detecting the one or more first data-plane packets comprises:
detecting the one or more first data-plane packets associated with a secure connection establishment process based on at least one of the following protocols: transport layer security (TLS) protocol and secure socket layer (SSL) protocol.

8. A non-transitory computer-readable storage medium that includes a set of instructions which, in response to execution by a processor of a first computer system, cause the processor to perform a method for policy configuration using a data-plane approach, wherein the method comprises:
detecting one or more first data-plane packets for establishing a connection between (a) a first virtualized computing instance supported by the first computer system and (b) a second computer system from which a resource is accessible;
extracting, from the one or more first data-plane packets, parameter information associated with the connection;
based on the parameter information, configuring a policy that is applicable for access control of the resource; and
in response to detecting a second data-plane packet to access the resource, applying the policy to allow or block forwarding of the second data-plane packet towards the second computer system, wherein the second data-plane packet originates from (a) the first virtualized computing instance or (b) a second virtualized computing instance supported by the first computer system.

9. The non-transitory computer-readable storage medium of claim 8, wherein extracting the parameter information comprises:
performing verification of the parameter information in the form of a digital certificate that is issued by a certificate authority, wherein the digital certificate is extractable from a particular first data-plane packet from the second computer system.

10. The non-transitory computer-readable storage medium of claim 9, wherein configuring the policy comprises:
configuring the policy based on at least one extensions field of the digital certificate, wherein the extensions field specifies an access control list associated with the resource.

11. The non-transitory computer-readable storage medium of claim 9, wherein the method further comprises:
generating and storing a cache entry associating the policy with a thumbprint of the digital certificate, wherein the cache entry is subsequently accessible to determine whether the policy has been configured.

12. The non-transitory computer-readable storage medium of claim 8, wherein configuring the policy comprises:
configuring the policy in the form of an identity firewall rule that is applicable by a firewall engine supported by the first computer system, wherein the identity firewall rule specifies at least one group of users that is permitted to access the resource.

13. The non-transitory computer-readable storage medium of claim 12, wherein applying the policy comprises:
determining whether a first user associated with the first virtualized computing instance, or a second user associated with the second virtualized computing instance, is a member of the group specified by the identity firewall rule.

14. The non-transitory computer-readable storage medium of claim 8, wherein detecting the one or more first data-plane packets comprises:
detecting the one or more first data-plane packets associated with a secure connection establishment process based on at least one of the following protocols:
transport layer security (TLS) protocol and secure socket layer (SSL) protocol.

15. A computer system, comprising:
a first virtualized computing instance;
a second virtualized computing instance;
a packet inspector to:
detect one or more first data-plane packets for establishing a connection between (a) the first virtualized computing instance and (b) a server from which a resource is accessible;
extract, from the one or more first data-plane packets, parameter information associated with the connection; and
configure a policy that is applicable for access control of the resource based on the parameter information; and
a policy manager to: in response to detecting a second data-plane packet to access the resource, apply the policy to allow or block forwarding of the second data- plane packet towards the server, wherein the second data-plane packet originates from (a) the first virtualized computing instance or (b) the second virtualized computing instance.

16. The computer system of claim 15, wherein the packet inspector is to extract the parameter information and configuring the policy by performing the following:
extract, from a particular first data-plane packet from the server, parameter information that includes a digital certificate that is issued by a certificate authority.

17. The computer system of claim 16, wherein the packet inspector is to configure the policy by performing the following:
configure the policy based on at least one extensions field of the digital certificate, wherein the extensions field specifies an access control list associated with the resource.

18. The computer system of claim 16, wherein the packet inspector is further to:
generate and store a cache entry associating the policy with a thumbprint of the digital certificate, wherein the cache entry is subsequently accessible to determine whether the policy has been configured.

19. The computer system of claim 15, wherein the packet inspector is to configure the policy by performing the following:
configure the policy in the form of an identity firewall rule that is applicable by a firewall engine supported by the first computer system, wherein the identity firewall rule specifies at least one group of users that is permitted to access the resource.

20. The computer system of claim 19, wherein the packet inspector is to apply the policy by performing the following:
determine whether a first user associated with the first virtualized computing instance, or a second user associated with the second virtualized computing instance, is a member of the group specified by the identity firewall rule.

21. The computer system of claim 15, wherein the packet inspector is to detect the one or more first data-plane packets by performing the following:
detect the one or more first data-plane packets associated with a secure connection establishment process based on at least one of the following protocols: transport layer security (TLS) protocol and secure socket layer (SSL) protocol.
